(19) United States
(12) Patent Application Publication
(10) Pub. No.: US 2021/0161216 A1
(43) Pub. Date: Jun. 3, 2021

(54) SYSTEM FOR FILLING DEVICE PARTS OF SIMULATED SMOKING DEVICES

(71) Applicant: Sluis Cigar Machinery B.V., Kampen (NL)

(72) Inventor: Oscar SLURINK, Heino (NL)

(21) Appl. No.: 17/261,499

(22) PCT Filed: Jul. 19, 2019
(86) PCT No.: PCT/NL2019/050463

§ 371 Date: Jan. 19, 2021

(30) Foreign Application Priority Data
Jul. 19, 2018 (NL) 2021346

(51) Int. Cl. A24F 40/70; A24F 40/10; B65B 57/00; B65B 1/46; B65B 3/28

(52) U.S. Cl. CPC A24F 40/70; A24F 40/10; B65B 3/28; B65B 1/46; B65B 57/00

(57) ABSTRACT

A system for filling device parts of simulated smoking devices, such as cartridges of electronic cigarettes, with a fluid, said system comprising a filling station to discharge a predetermined amount of fluid in each of the device parts, a weighing station to individually weigh the device parts filled by the filling station, which weighing station provides a measurement signal for each of the device parts, and a control unit to determine if the predetermined amount of fluid has been discharged in each of the device parts on basis of the measurement signal, which control unit is in communication with the weighing station.

### FIELD OF THE INVENTION

The invention relates to a system for filling device parts of simulated smoking devices, such as cartridges of electronic cigarettes, with a fluid. The system comprises a filling station to discharge a predetermined amount of fluid in each of the device parts.

### BACKGROUND OF THE INVENTION

The invention is based on the insight that in practice the filling station does not always discharge the same amount of the fluid in the device parts. Therefore, there is a need to accurately determine if a right quantity of fluid has been discharged in each of the device parts.

### SUMMARY OF THE INVENTION

The invention has the objective to provide an improved or at least alternative system for filling device parts of simulated smoking devices.

This objective is reached by a system for filling device parts of simulated smoking devices, such as cartridges of electronic cigarettes, with a fluid, said system comprising;

a filling station to discharge a predetermined amount of fluid in each of the device parts,

a weighing station to individually weigh the device parts filled by the filling station, which weighing station provides a measurement signal for each of the device parts,

a control unit to determine if the predetermined amount of fluid has been discharged in each of the device parts on basis of the measurement signal, which control unit is in communication with the weighing station,

a transport device to move the device parts along a production trajectory wherein;

the production trajectory extends through the filling station and the weighing station,

the transport device is configured to move a batch of at least one device part in at least one weighing position located in a weighing trajectory part of the production trajectory and subsequently out of the at least one weighing position, which weighing trajectory part extends through the weighing station,

the transport device comprises at least one transport support member to fully support the batch of at least one device part in a vertical direction during movement along the weighing trajectory part,

the weighing station comprises at least one weighing support member located at the at least one weighing position to support the batch of at least one device part during weighing by the weighing station, and

the at least one transport support member and the at least one weighing support member are movable relative to each other in the vertical direction;

from a transport configuration in which the batch of at least one device part is fully supported in the vertical direction by the at least one transport support member to move the batch of at least one device part into the at least one weighing position and subsequently out of the at least one weighing position,

into a weighing configuration in which the batch of at least one device part located in the weighing position is fully supported in the vertical direction by the at least one weighing support member to weigh the batch of at least one device part with the weighing station, and vice versa.

The specific construction of the weighing station and the transport device ensures that the control unit can accurately determine if a right quantity of fluid has been discharged in each of the device parts.

In an embodiment of the system, the transport device is configured to move the device parts first through the filling station and subsequently through the weighing station.

In an embodiment of the system, the at least one transport support member comprises at least one or only one support rail which extends along the weighing trajectory part and the batch of at least one device part is in the transport configuration supported by the at least one or only one support rail.

In an embodiment of the system, the batch of at least one device part is in the transport configuration fully supported by the at least one or only one support rail.

In an embodiment of the system, the transport device comprises moving members for moving the batch of at least one device part along the weighing trajectory part and/or a guide member extending along the further weighing trajectory part, the at least one transport support member comprises support surfaces provided in the moving members and/or guide member, and the batch of at least one device part is in the transport configuration supported by the support surfaces.

In an embodiment of the system, the batch of at least one device part is in the transport configuration fully supported by the support surfaces.

In an embodiment of the system, each weighing support member supports in the weighing configuration one and only one device part of the batch at least one of device part.

In an embodiment of the system, the batch of at least one device part located in the at least one weighing position is in the weighing configuration only supported by the at least one weighing support member.

In an embodiment of the system, the at least one transport support member and the at least one weighing support member are both moveable in the vertical direction to change from the transport configuration into the weighing configuration, and vice versa.

In an embodiment of the system, only the at least one transport support member is moveable in the vertical direction to change from the transport configuration into the weighing configuration, and vice versa.

In an embodiment of the system, the at least one weighing support member is stationary.

In an embodiment of the system, only the at least one weighing support member is moveable in the vertical direction to change from the transport configuration into the weighing configuration, and vice versa. In said embodiment, the at least one transport support member may be stationary.

In an embodiment of the system;

the system comprises a further weighing station to individually weigh the device parts before filling by the filling station, which further weighing station provides a further measurement signal for each of the device parts,

the control unit is in communication with the further weighing station to determine if the predetermined amount of fluid has been discharged in each of the device parts on basis of the measurement signal and the further measurement signal,

the production trajectory extends through the further weighing station,

the transport device is configured to move the batch of at least one device part in at least one further weighing position located in a further weighing trajectory part of the production trajectory and subsequently out of the at least one further weighing position, which further weighing trajectory part extends through the further weighing station,

the transport device comprises at least one further transport support member to fully support the batch of at least one device part in the vertical direction during movement along the further weighing trajectory part,

the further weighing station comprises at least one further weighing support member located at the at least one further weighing position to support the batch of at least one device part during weighing by the further weighing station,

the at least one further transport support member and the at least one further weighing support member are movable relative to each other in the vertical direction;

from a further transport configuration in which the batch of at least one device part is fully supported in the vertical direction by the at least one further transport support member to move the batch of at least one device part into the at least one further weighing position and subsequently out of the at least one further weighing position,

into a further weighing configuration in which the batch of at least one device part located in the further weighing position is fully supported in the vertical direction by the at least one further weighing support member to individually weigh each device part of the batch of at least one device part with the further weighing station, and vice versa.

In an embodiment of the system, the transport device is configured to move the device parts first through the further weighing station, after that through the filling station and subsequently through the weighing station.

In an embodiment of the system, the at least one further transport support member comprises at least one or only one further support rail which extends along the further weighing trajectory part and the batch of at least one device part is in the further transport configuration supported by the at least one or only one further support rail.

In an embodiment of the system, the batch of at least one device part is in the further transport configuration fully supported by the at least one or only one further support rail.

In an embodiment of the system, the transport device comprises further moving members for moving the batch of at least one device part along the further weighing trajectory part and/or a further guide member extending along the further weighing trajectory part, the at least one further transport support member comprises further support surfaces provided in the further moving members and/or further guide member, and the batch of at least one device part is in the further transport configuration supported by the further support surfaces.

In an embodiment of the system, the moving members and the further moving members are the same moving members.

In an embodiment of the system, the batch of at least one device part is in the further transport configuration fully supported by the further support surfaces.

In an embodiment of the system, each further weighing support member supports in the further weighing configuration one and only one device part of the batch of at least one of device part.

In an embodiment of the system, the batch of at least one device part located in the at least one further weighing position is in the further weighing configuration only supported by the at least one further weighing support member.

In an embodiment of the system, the at least one further transport support member and the at least one further weighing support member are both moveable in the vertical direction to change from the further transport configuration into the further weighing configuration, and vice versa.

In an embodiment of the system, only the at least one further transport support member is moveable in the vertical direction to change from the further transport configuration into the further weighing configuration, and vice versa.

In an embodiment of the system, the at least one further weighing support member is stationary.

In an embodiment of the system, only the at least one further weighing support member is moveable in the vertical direction to change from the further transport configuration into the further weighing configuration, and vice versa. In said embodiment, the at least one further transport support member may be stationary.

In an embodiment of the system, the transport device is configured to move the batch of at least one device part along the production trajectory in an intermittent manner.

In an embodiment of the system, the transport device is configured to move the at least one transport support member in the vertical direction and/or the weighing station is configured to move the at least one weighing support member in the vertical direction in order to move the at least one transport support member and the at least one weighing support member relative to each other from the transport configuration into the weighing configuration, and vice versa.

In an embodiment of the system, the transport device is configured to intermittently move subsequent batches of at least one device part along the production trajectory and in the at least one weighing position.

In an embodiment of the system, the transport device is configured to for a predetermined time period stop the movement along the production trajectory of the batch of at least one device part being located in the at least one weighing position.

In an embodiment of the system, the transport device and/or the weighing station are/is configured to move the at least one transport support member and the at least one weighing support member relative to each other from the transport configuration into the weighing configuration, and subsequently back into the transport configuration within the predetermined time period.

In an embodiment of the system, the transport device is configured to move the at least one further transport support member in the vertical direction and/or the further weighing station is configured to move the at least one further weighing support member in the vertical direction in order to move the at least one further transport support member and the at least one further weighing support member relative to each other from the further transport configuration into the further weighing configuration, and vice versa.

In an embodiment of the system, the transport device is configured to intermittently move subsequent batches of at least one device part along the production trajectory and in the at least one further weighing position.

In an embodiment of the system, the transport device is configured to for a further predetermined time period stop the movement along the production trajectory of the batch of at least one device part being located in the at least one further weighing position.

In an embodiment of the system, the transport device and/or the further weighing station are/is configured to move the at least one further transport support member and the at least one further weighing support member relative to each other from the further transport configuration into the further weighing configuration, and subsequently back into the further transport configuration within the further predetermined time period.

### BRIEF DESCRIPTION OF THE DRAWINGS

Embodiments of the system according to the invention will be described by way of example only, with reference to the accompanying schematic drawings in which corresponding reference symbols indicate corresponding parts, and in which:

the FIGS. 1A-D schematically show views in perspective of an embodiment of the system according to the invention,

the FIGS. 2A-C schematically show top views of the system of FIG. 1 and its production trajectory,

FIG. 3 schematically show an enlarged view in perspective of the filling station of the system of FIG. 1,

the FIGS. 4A-E schematically show enlarged views in perspective of the weighing station of the system of FIG. 1,

FIG. 5A schematically shows a simplified enlarged view in perspective of the weighing station of the system of FIG. 1 in the transport configuration,

FIG. 5B schematically shows a frontal view of the weighing station FIG. 5A,

FIG. 5C schematically shows a cross sectional view of the weighing station along line C-C of FIG. 5A,

FIG. 6A schematically shows a simplified enlarged view in perspective of the weighing station of the system of FIG. 1 in the weighing configuration,

FIG. 6B schematically shows a frontal view of the weighing station FIG. 6A,

FIG. 6C schematically shows a cross sectional view of the weighing station along line C-C of FIG. 6A,

FIG. 7A shows a view in perspective of a first alternative embodiment of the weighing station and transport device in the transport configuration,

FIG. 7B schematically shows a cross sectional view of the first alternative weighing station and transport device along line B-B of FIG. 7A,

FIG. 8A shows a view in perspective of the first alternative embodiment of the weighing station and transport device in the weighing configuration,

FIG. 8B schematically shows a cross sectional view of the first alternative weighing station and transport device along line B-B of FIG. 8A,

FIG. 9A shows a view in perspective of a second alternative embodiment of the weighing station and transport device in the transport configuration,

FIG. 9B schematically shows a cross sectional view of the second alternative weighing station and transport device along line B-B of FIG. 9A,

FIG. 10A shows a view in perspective of the second alternative embodiment of the weighing station and transport device in the weighing configuration, and

FIG. 10B schematically shows a cross sectional view of the second alternative weighing station and transport device along line B-B of FIG. 10A.

### DETAILED DESCRIPTION OF THE DRAWINGS

The FIGS. 1A-D show views in perspective of an embodiment of the system 1 according to the invention. The system 1 is configured to fill device parts 2 of simulated smoking devices, such as cartridges 4 of electronic cigarettes, with a fluid 3. In the shown system 1, the fluid 3 is a liquid. In alternative embodiments of the system 1 (not shown), the fluid 3 may comprise a powder or a gel.

In the shown system 1, each device part 2 comprises a product carrier 15 which will not be part of the simulated smoking device ready for use. It will be clear for the skilled person that the system 1 according to the invention can also operate with device parts 2 not having a product carrier 15 and that the invention is therefore not limited to the use of device parts 2 having a product carrier 15.

Along the same line of reasoning, it will be also be clear that the system 1 according to the invention can operate with completely constructed simulated smoking devices (with or without product carrier 15), which simulated smoking devices only needs to be filled in order to be ready for use. In this situation, the completely constructed simulated smoking devices are the device parts 2 as defined in the claims.

The system 1 comprises a filling station 6 to discharge a predetermined amount of fluid 3 in each of the device parts 2 and a weighing station 7 to individually weigh the device parts 2 filled by the filling station 6. The weighing station 7 provides a measurement signal for each of the device parts 2. The system 1 further comprises a control unit 8 to determine if the predetermined amount of fluid 3 has been discharged in each of the device parts 2 on basis of the measurement signal. The control unit 8 is in communication with the weighing station 7.

A transport device 50 is provided to move the device parts 2 along a production trajectory 9 (see FIG. 2C). The production trajectory 9 extends through the filling station 6 and the weighing station 7. The transport device 50 is configured to move a batch 11 of ten device parts 2 in ten weighing positions 12 located in a weighing trajectory part 13 of the production trajectory 9 and subsequently out of the ten weighing positions 12. The weighing trajectory part 13 extends through the weighing station 7. In an alternative embodiment of the system 1 (not shown), the batch 11 of device parts 2 may have a different number of device parts 2.

The system 1 comprises a further weighing station 107 to individually weigh the device parts 2 before being filled by the filling station 6. The further weighing station 107 provides a further measurement signal for each of the device parts 2. The control unit 8 is in communication with the further weighing station 107 to determine if the predetermined amount of fluid 3 has been discharged in each of the device parts 2 on basis of the measurement signal and the further measurement signal.

The production trajectory 9 extends also through the further weighing station 107. The transport device 50 is configured to move the batch 11 of ten device parts 2 in ten further weighing positions 112 located in a further weighing trajectory part 113 of the production trajectory 9 and subsequently out of the ten further weighing positions 112. The further weighing trajectory part 113 extends through the further weighing station 107. The transport device 50 is configured to move the device parts 2 first through the further weighing station 107, after that through the filling station 6 and subsequently through the weighing station 7.

This allows that the amount of fluid 3 discharged in each device part 2 can be determined on basis of the increased weight measured by the weighing station 7 when compared with the measurements of the further weighing station 107. This provides a very accurate measurement of the amount of fluid 3 discharged in the device part 2.

Alternative embodiments of the system 1 (not shown) may only have the weighing station 7 and no further weighing station 107. In said situation, the transport device 50 moves the device parts 2 first through the filling station 6 and subsequently through the weighing station 7. It is assumed that the mass of the device parts 2 is known and this allows that the control unit 8 determines the amount of fluid 3 discharged in the device parts 2 on basis of the measurement performed by the weighing station 7.

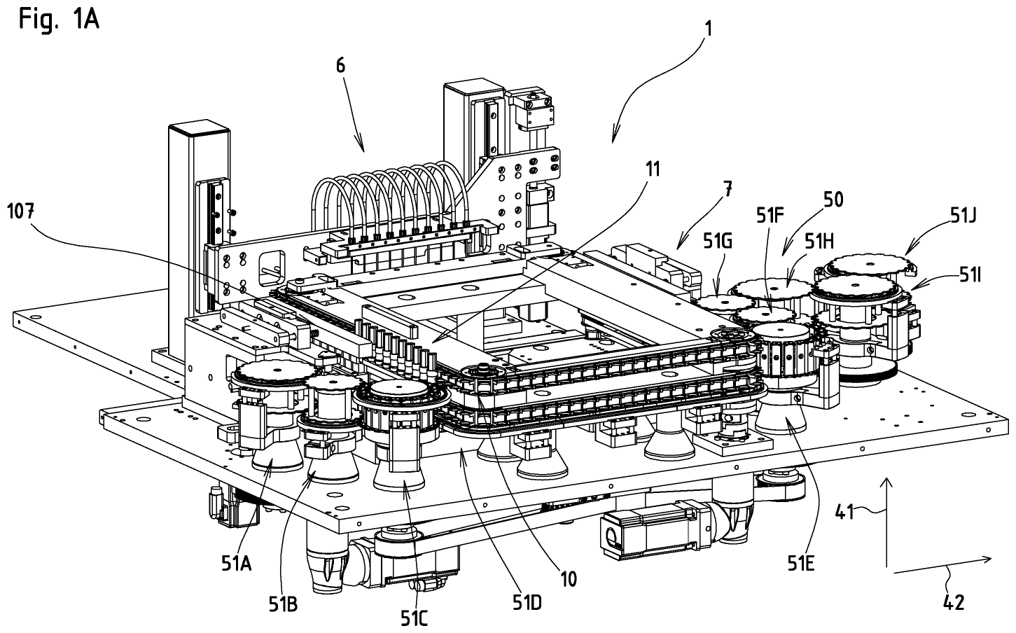

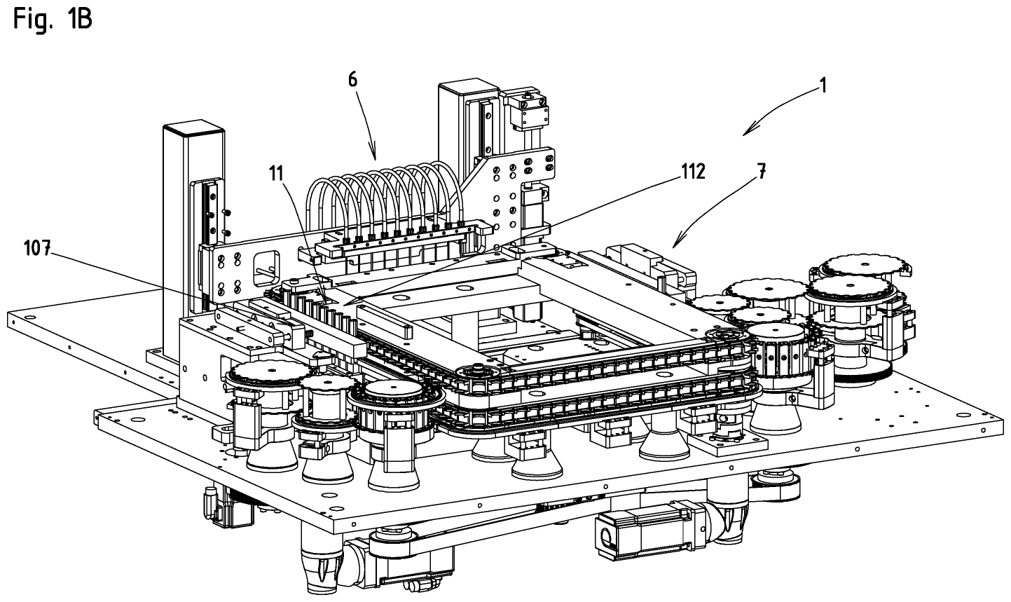

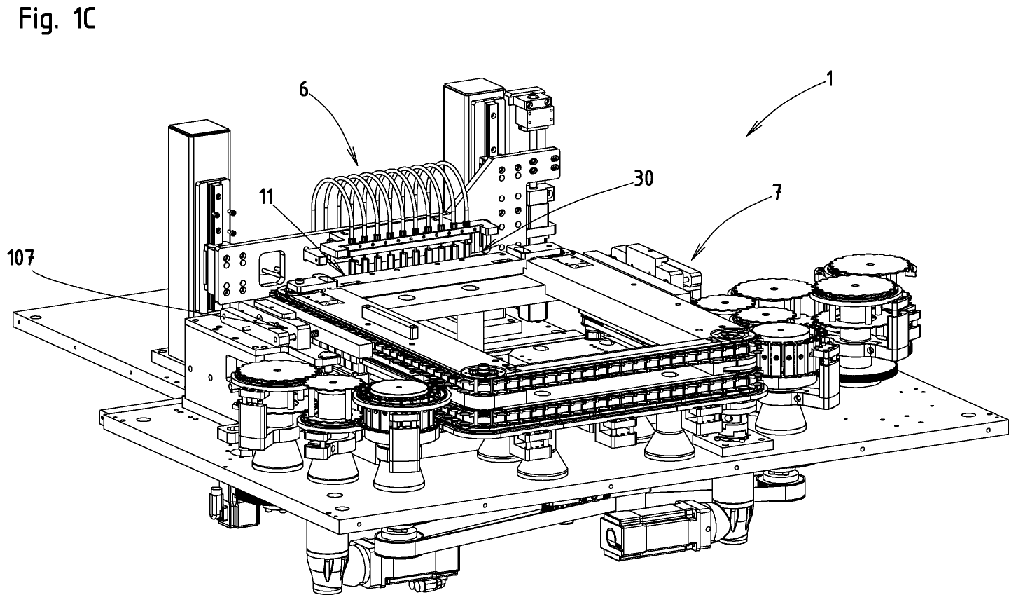

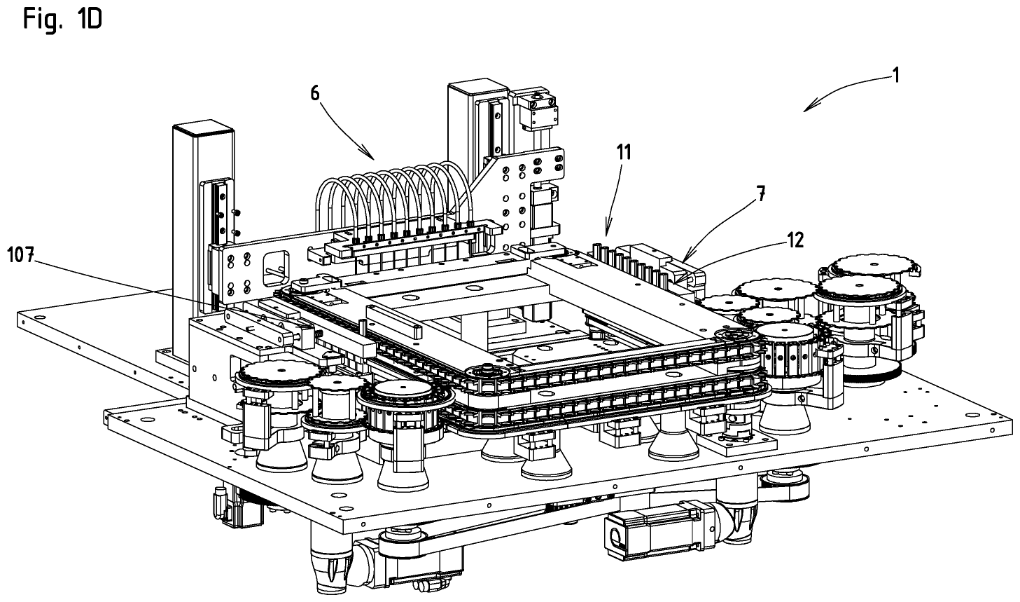

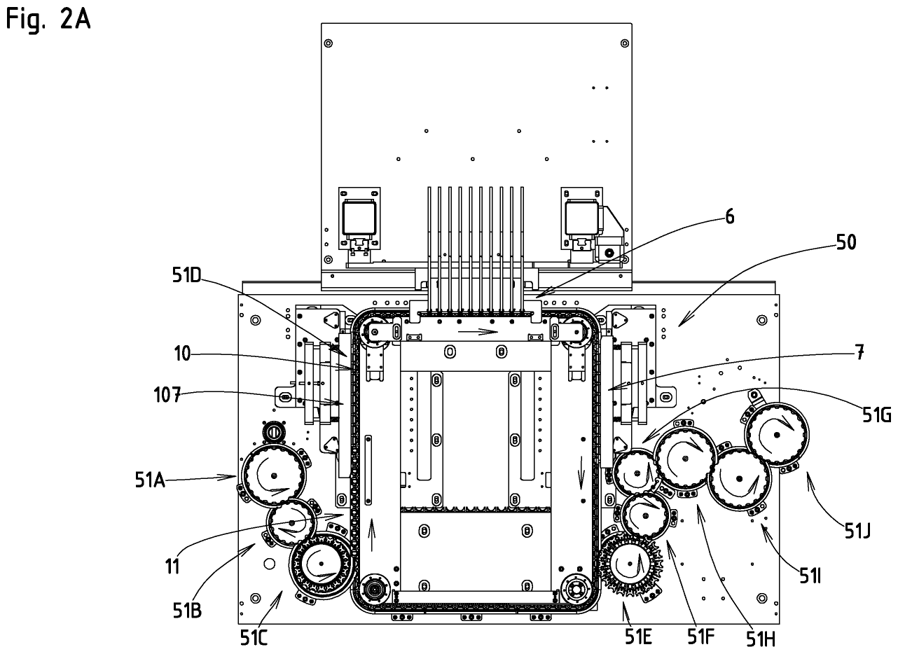

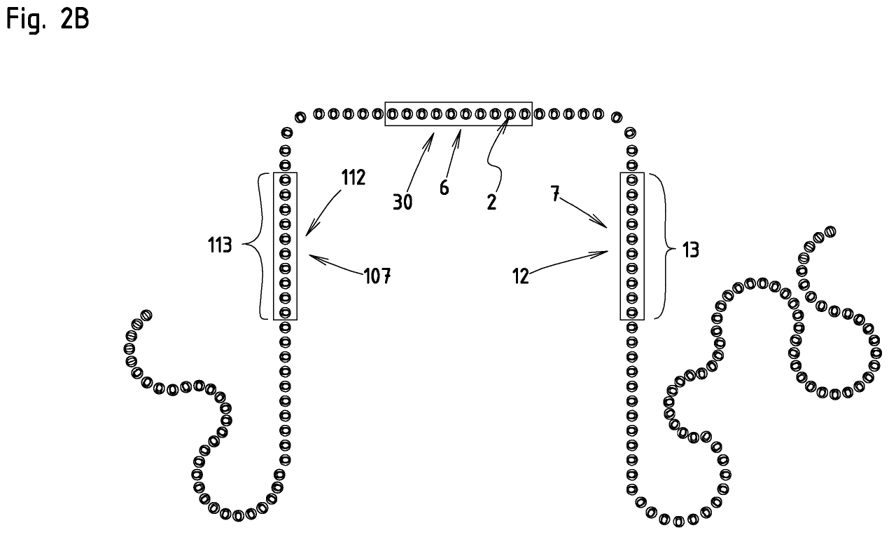

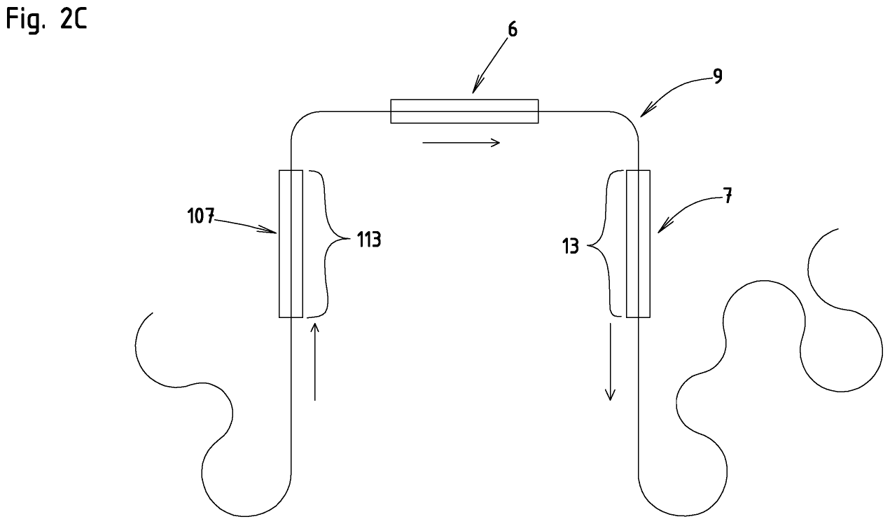

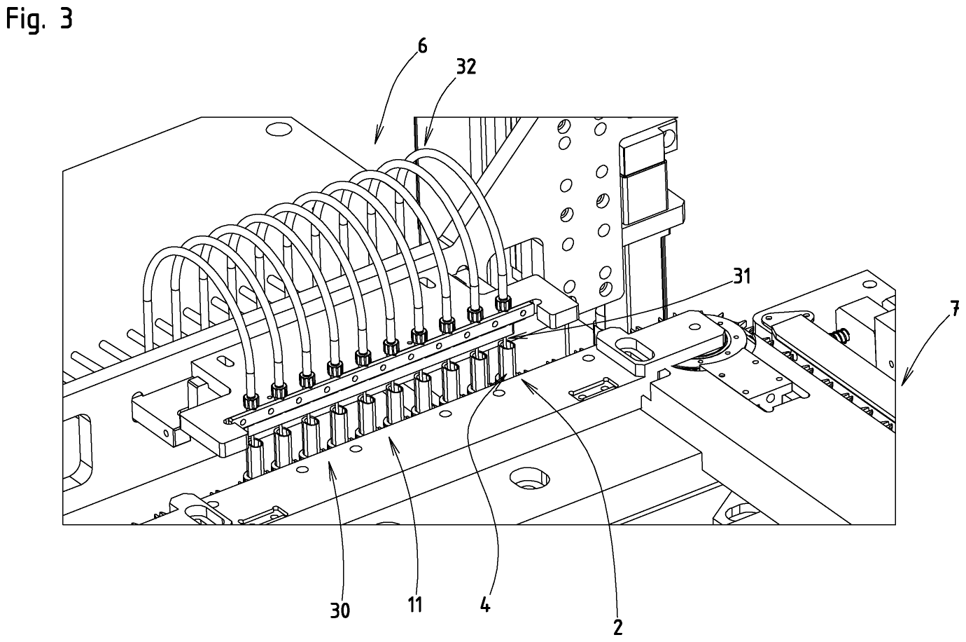

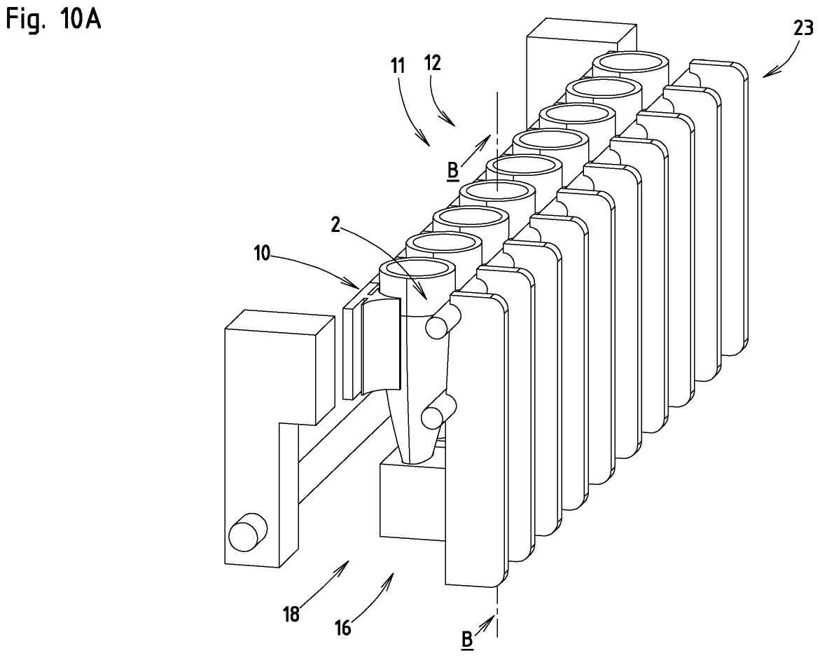

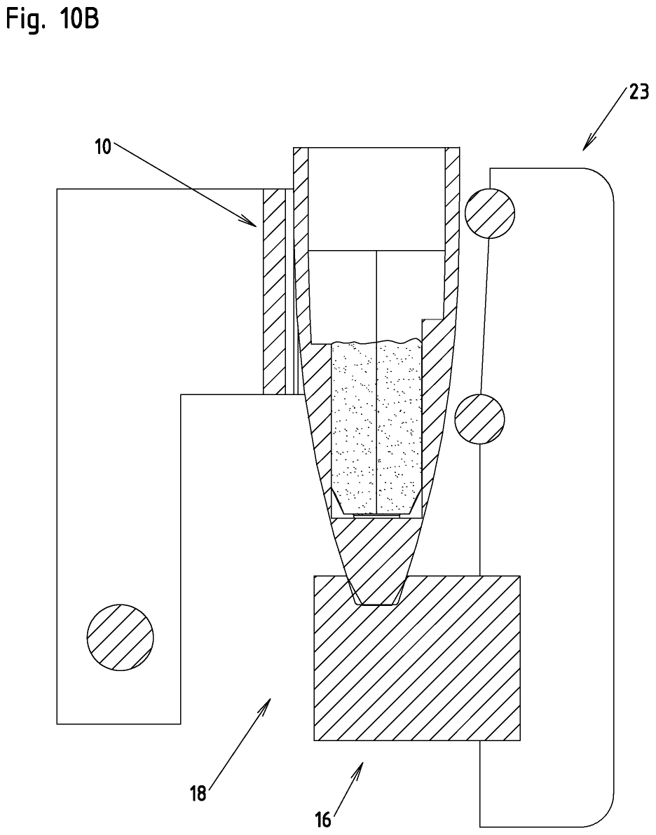

In FIG. 1A, the batch 11 of device parts 2 is moved by the transport device 50 towards the further weighing positions 112. In FIG. 1B, the device parts 2 are located in the further weighing positions 112. In FIG. 1C, the batch 11 of device parts 2 is located at the filling station 6 and the device parts 2 are being filled with the liquid. An enlarged view of the filling of the device parts 2 is shown in FIG. 3. The device parts are located in filling positions 30 and filled via filling needles 31 connected to a fluid supply 32. In FIG. 10, the device parts 2 have been moved into the further weighing positions 112.

FIG. 2A shows a top view of the situation of FIG. 1A. Only the batch 11 of ten device parts 2 is shown. The transport device 50 comprises ten transport units 51A-J which in cooperation moves the batch 11 of device parts 2 along the production trajectory 9. It in practice, subsequent batches 11 of ten device parts 2 are position one after the other along the production trajectory 9. This is show in FIG. 2B. The transport device 50 moves these batches 11 of device parts 2 along the production trajectory 9 in an intermittent manner. The production trajectory 9 is indicated in FIG. 2C.

The transport device 50 comprises a transport support member 14 to fully support the batch 11 of device parts 2 in a vertical direction 41 during movement along the weighing trajectory part 13. The vertical direction 41 and the horizontal direction 42 are indicated in FIG. 1A.

In FIG. 4A, the batch 11 of filled device parts 2 is moved by the transport device 50 from the filling station 6 towards the weighing station 7. More specifically, the batch 11 of filled device parts 2 is moved by the transport unit 50D of the transport device 50. The transport device 50 comprises moving members 10 for moving the batch 11 of device part 2. The same moving members 10 move the batch 11 of the device parts 2 through the further weighing station 107 and the weighing station 7. In FIG. 4B, the device parts 2 are located in the weighing positions 12. During this movement into the weighing positions 12, the device parts 2 are along the weighing trajectory part 13 in the vertical direction 41 fully supported by the transport support member 14.

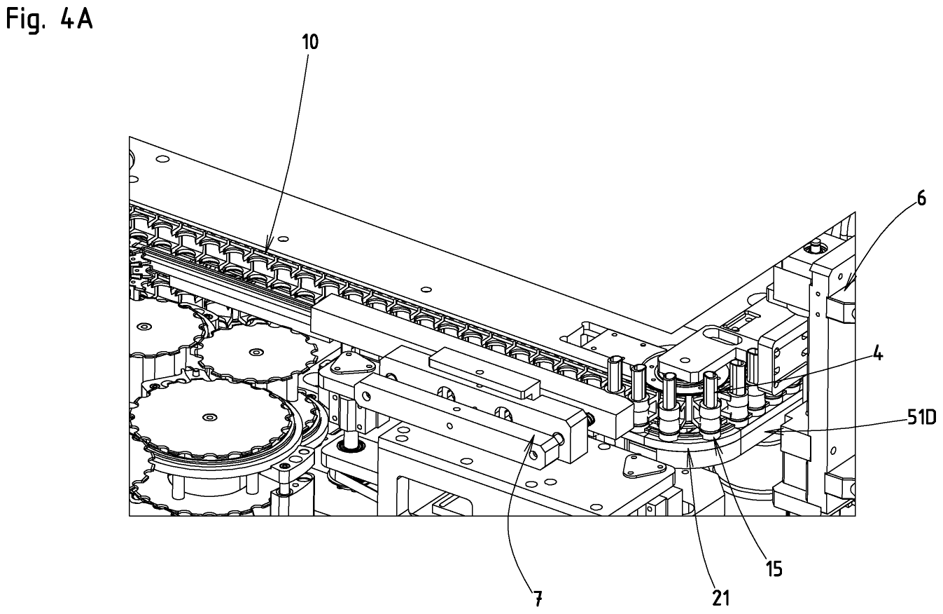

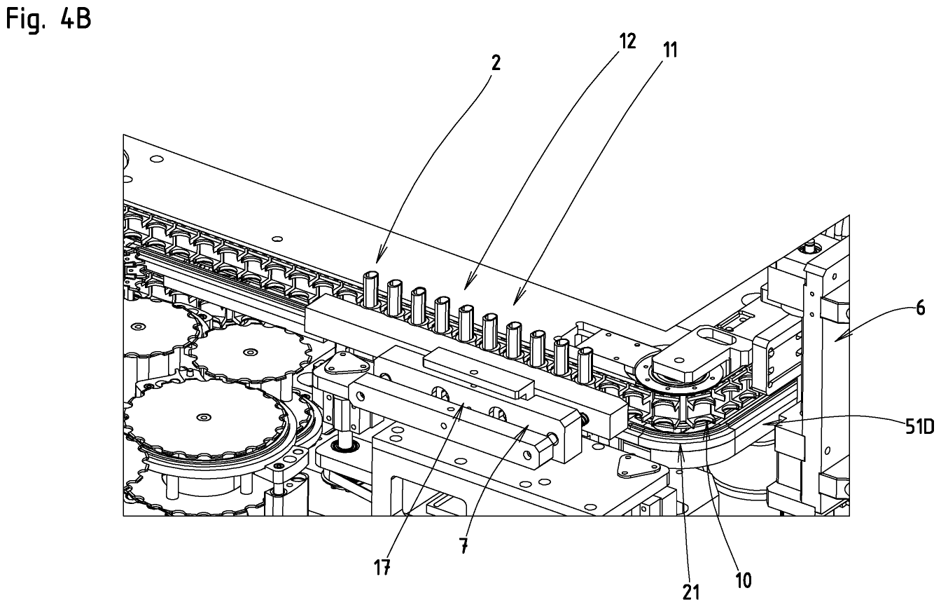

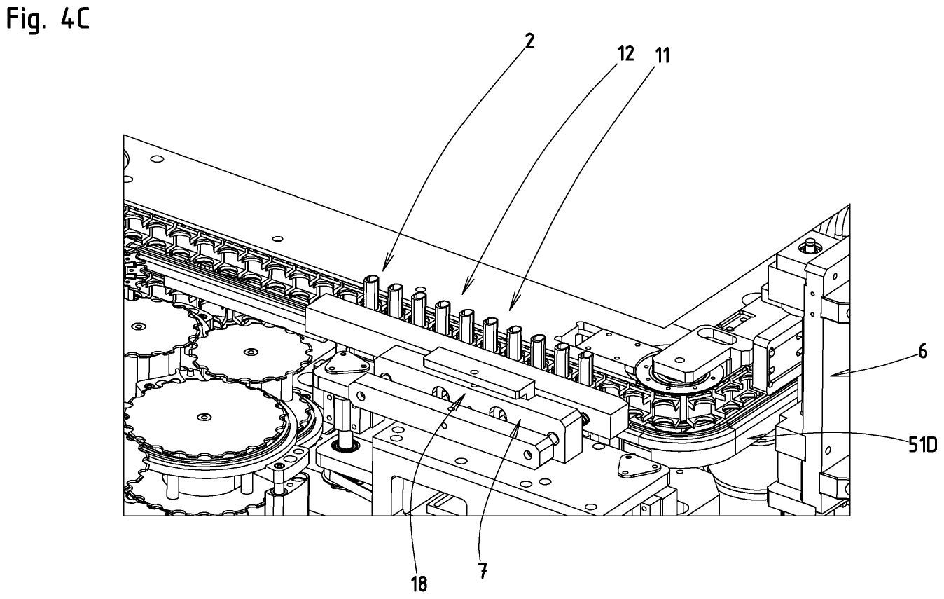

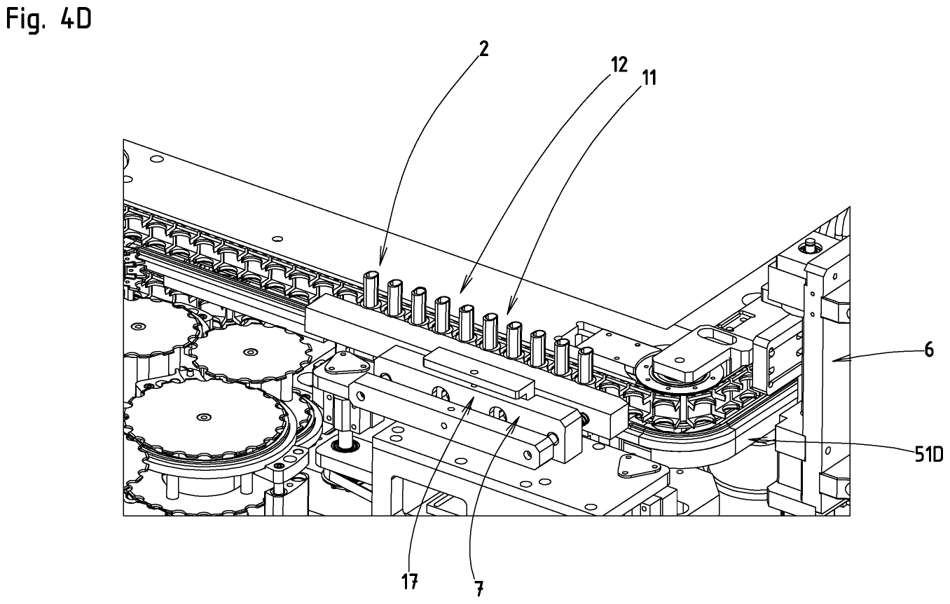

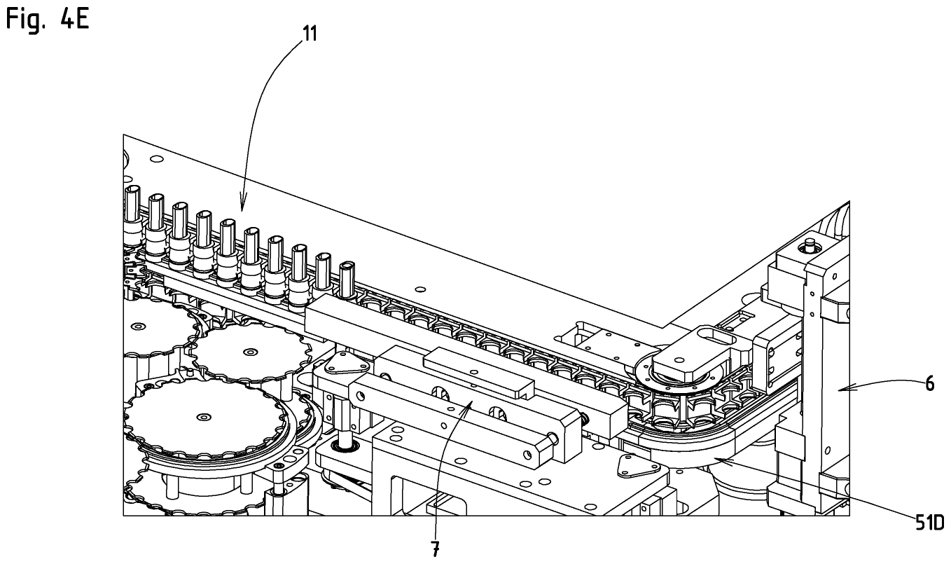

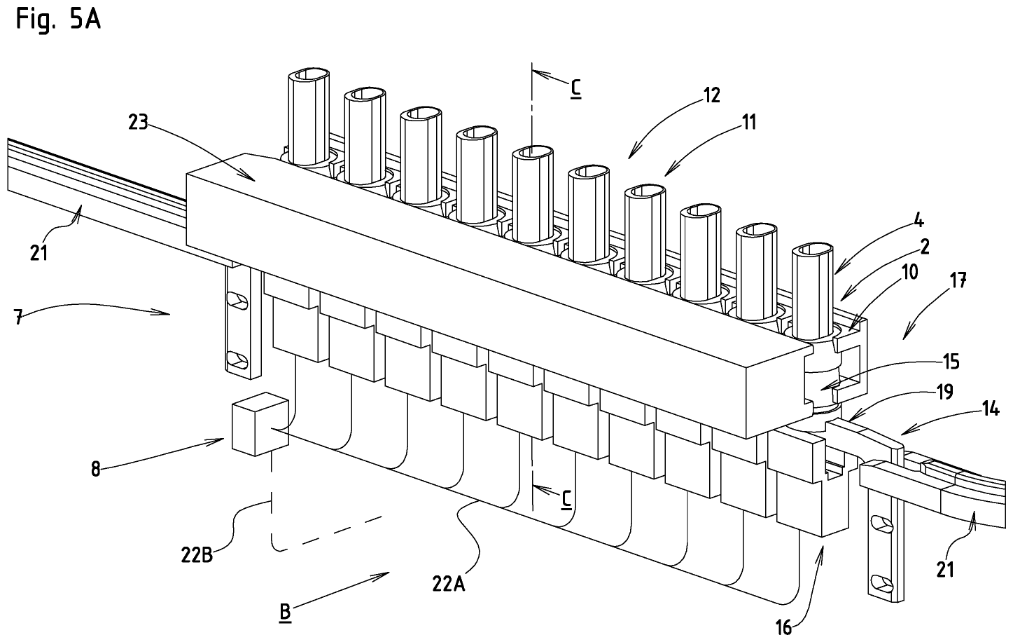

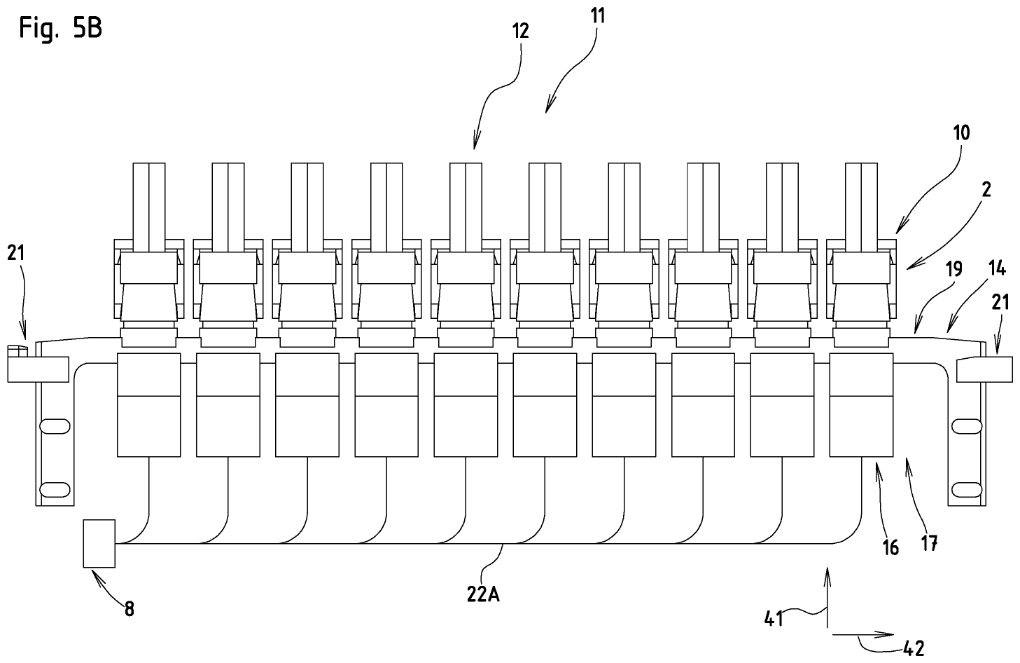

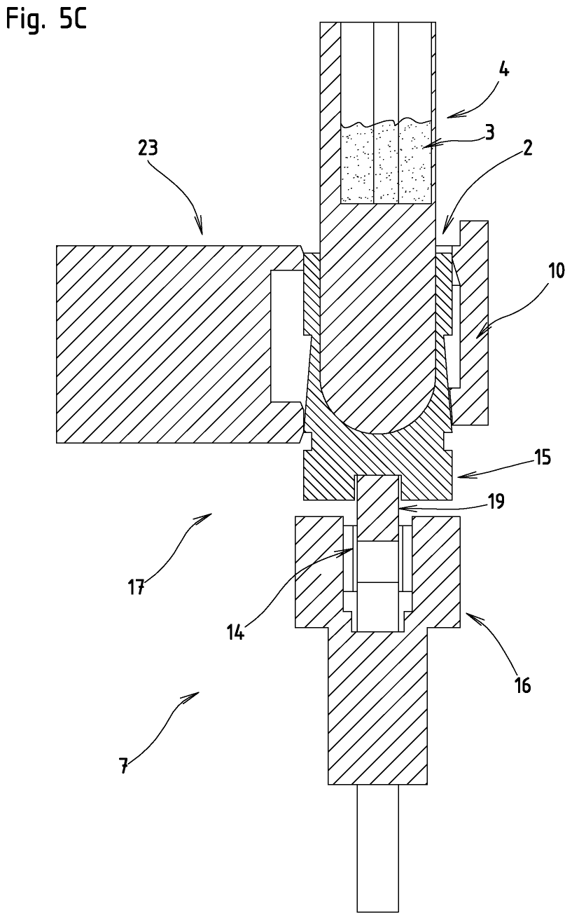

FIG. 5A shows the situation of FIG. 4B, wherein several parts of the system 1 are removed to obtain a clear view on relevant parts of the transport device 50 and weighing station 7. The transport support member 14 comprises a support rail 19 which extends along the weighing trajectory part 13. The support rail 19 is located between guide rails 21 to allow that the device parts 2 are moved towards and away from the weighing trajectory part 13.

The weighing station 7 comprises ten weighing support members 16 located at the ten weighing positions 12 to support the batch 11 of ten device parts 2 during weighing by the weighing station 7.

The transport support member 14 and the ten weighing support members 16 are movable relative to each other in the vertical direction 41 and in the shown situation located in a transport configuration 17 in which the batch 11 of device parts 2 is fully supported in the vertical direction 41 by the transport support member 14. The transport configuration 17 allows that the batch 11 of device parts 2 is moved into the weighing positions 12 and subsequently out of the weighing positions 12.

FIG. 5B shows a frontal view of the transport configuration 17 of FIG. 5A. One can clearly see that the device parts 2 are in the vertical direction 41 fully supported by the support rail 19. The product carries are located at a distance from the weighing support members 16. This can also be seen in FIG. 5C which shows a cross sectional view of the weighing station 7 along line C-C of FIG. 5A. During movement of the device parts 2 along the weighing trajectory part 13, the device parts 2 are held in an upright position by the moving members 10 and a guide member 23. In case that in the transport configuration 17 there may be some friction in the vertical direction 41 between the device parts 2 and the moving members 10 and/or the guide member 23, the moving members 10 and/or the guide member 23 form support surfaces which act as additional transport support members 14 contributing to the full support of the device parts 2.

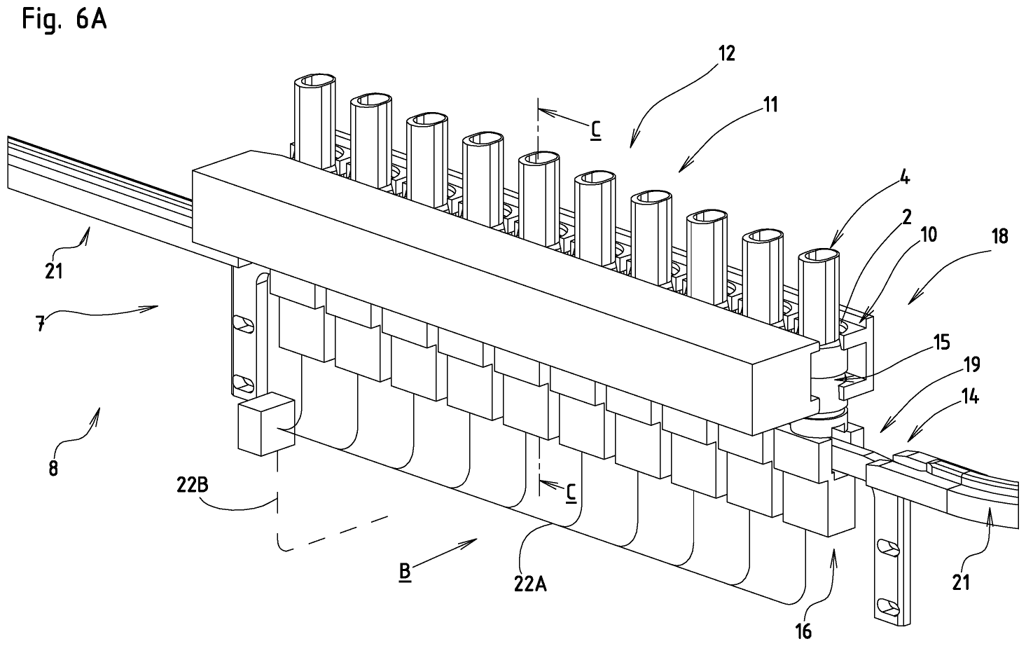

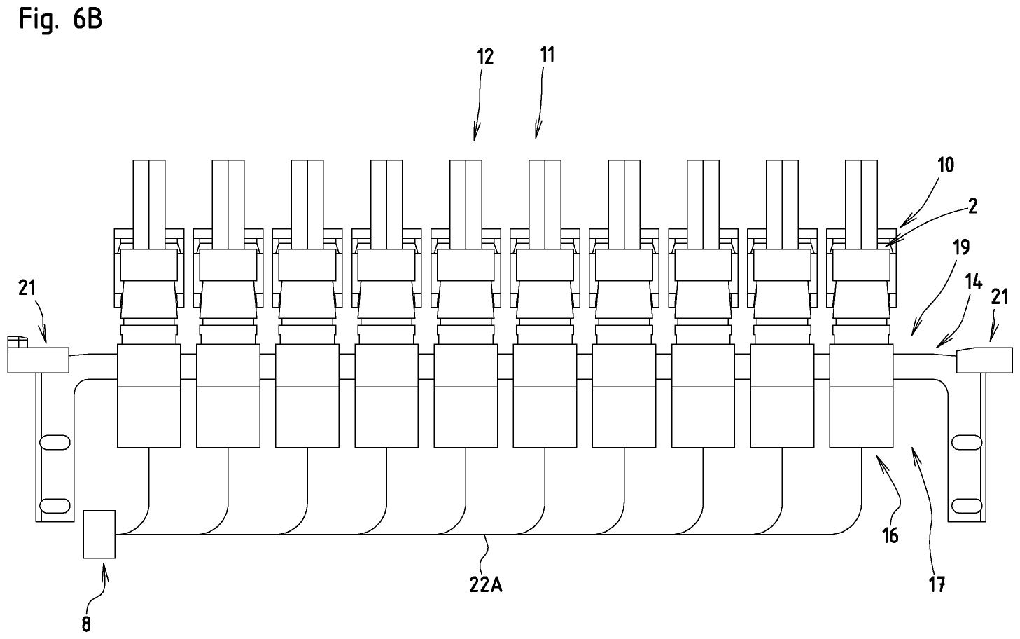

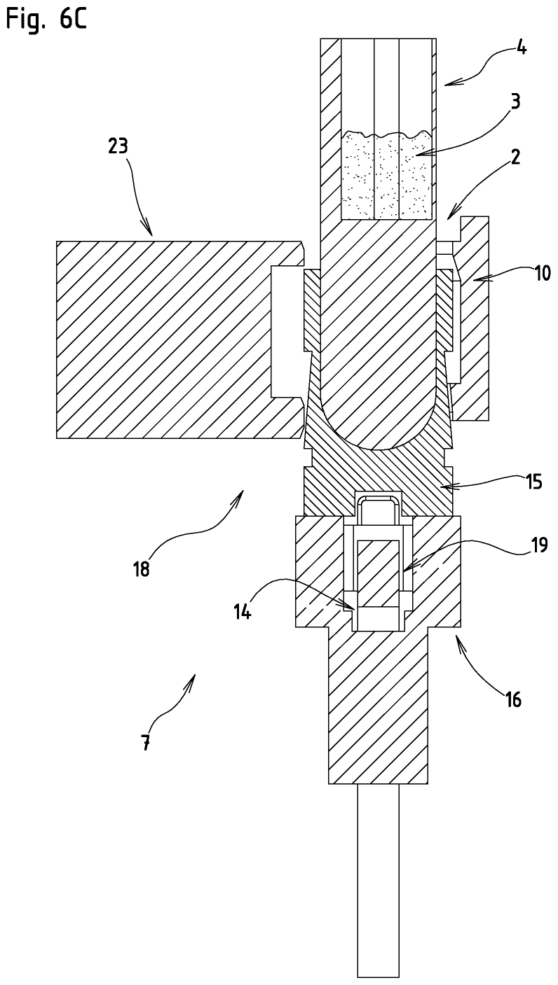

In FIG. 4C, the device parts 2 are still located in the weighing positions 12 and the transport device 50 and the weighing station 7 have changed to the weighing configuration 18. FIG. 6A shows the situation of FIG. 4C, wherein again several parts of the system 1 are removed to obtain a clear view. The device parts 2 located in the weighing position 12 are fully supported in the vertical direction 41 by the weighing support members 16 to individually weigh each device part 2 of the batch 11 with the weighing station 7.

FIG. 6B shows a frontal view of the weighing configuration 18 of FIG. 6A. One can clearly see that each weighing support member 16 supports one and only one device part 2. This can also be seen in FIG. 6C which shows a cross sectional view of the weighing station 7 along line C-C of FIG. 6A. FIG. 6C also shows that there is no contact between the device part 2 and the moving member 10 and the guide member 23. The device parts 2 are only supported by the weighing support members 16. This ensures that the weight can be measured in an accurate manner.

In FIG. 4D, the device parts 2 are still located in the weighing positions 12 and the transport device 50 and the weighing station 7 have changed back to the transport configuration 17. Subsequently, the device parts 2 are moved out of the weighing positions 12 (FIG. 4E).

In the shown system 1, only the transport support member 14 is moveable in the vertical direction 41 to change from the transport configuration 17 into the weighing configuration 18, and vice versa. This means that the weighing support members 16 can remain stationary. This is beneficial for an accurate weighing station 7, because moving parts might have negative effects on the accuracy of the measurements.

In an alternative system 1 (not shown), the transport support member 14 and the weighing support members 16 are both moveable in the vertical direction 41 to change from the transport configuration 17 into the weighing configuration 18, and vice versa.

In another alternative system 1 (not shown), only the at least one weighing support member 16 is moveable in the vertical direction 41 to change from the transport configuration 17 into the weighing configuration 18, and vice versa.

The further weighing station 107 is constructed and operates in the same manner as the weighing station 7.

As shown in the FIGS. 5A and B and 6A and B, each weighing support member 16 of the weighing station 7 is connected to the control unit 8 via a communication line 22A. Each further weighing support member (not shown) of the further weighing station 107 is connected to the control unit 8 via a further communication line 22B. The control unit 8 is configured to determine if the predetermined amount of fluid 3 has been discharged in each of the device parts 2 on basis of the measurement signal provided by the weighing station 7 and the further measurement signal provided by the further weighing station 107.

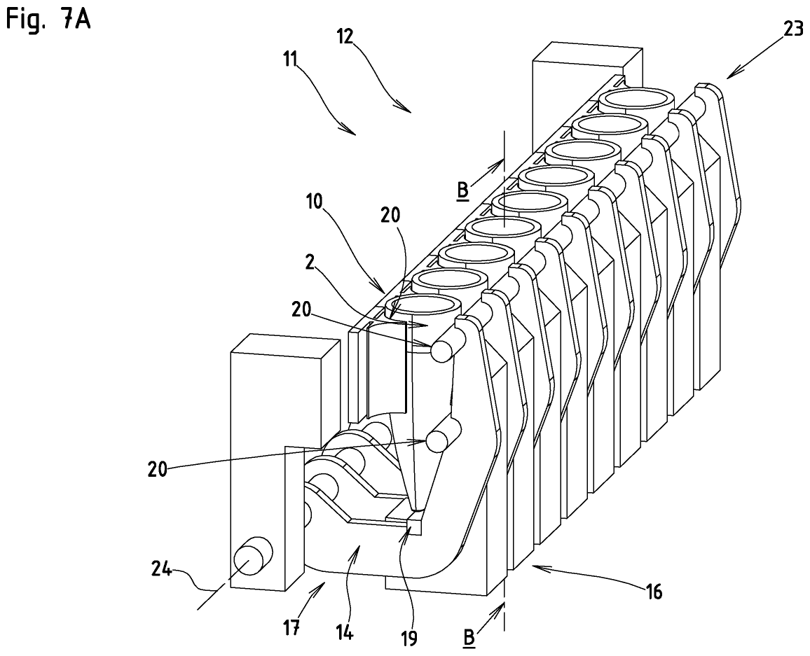

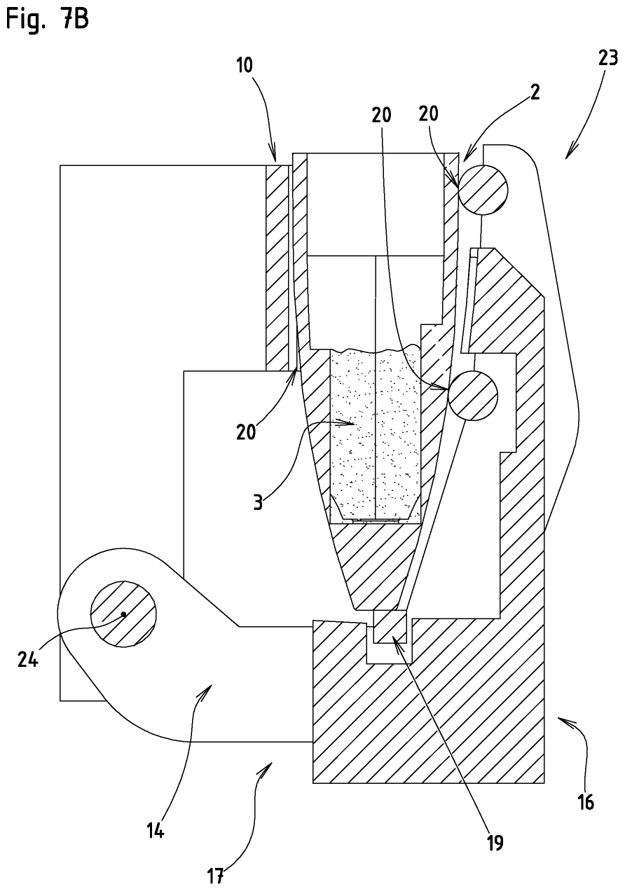

FIG. 7A a view in perspective of a first alternative embodiment of the weighing station 7 and transport device 50 in the transport configuration 17. FIG. 7B shows a cross sectional view of the first alternative weighing station 7 and transport device 50 along line B-B of FIG. 7A. The device parts 2 are located in the weighing positions 12 and are in the vertical direction 41 fully supported by the transport support members 14 formed by the support rail 19 and the supports surfaces 20 provided by the moving members 10 and the guide member 23.

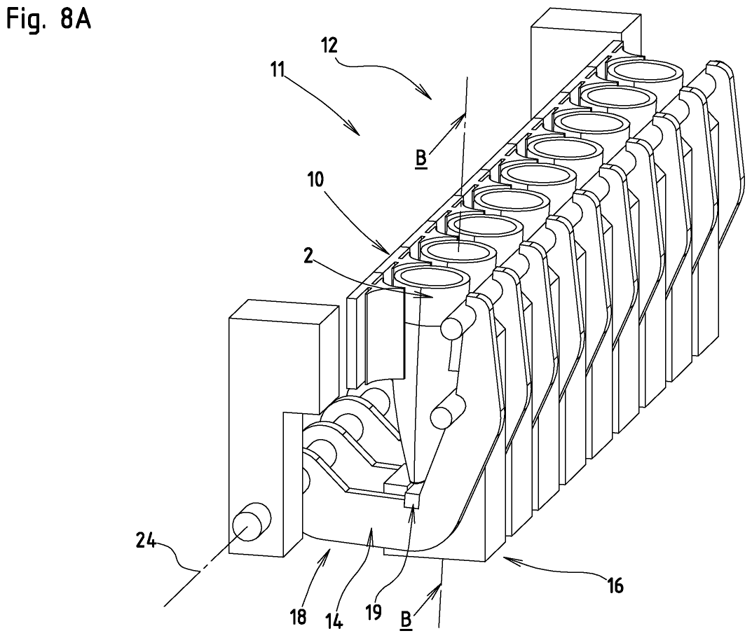

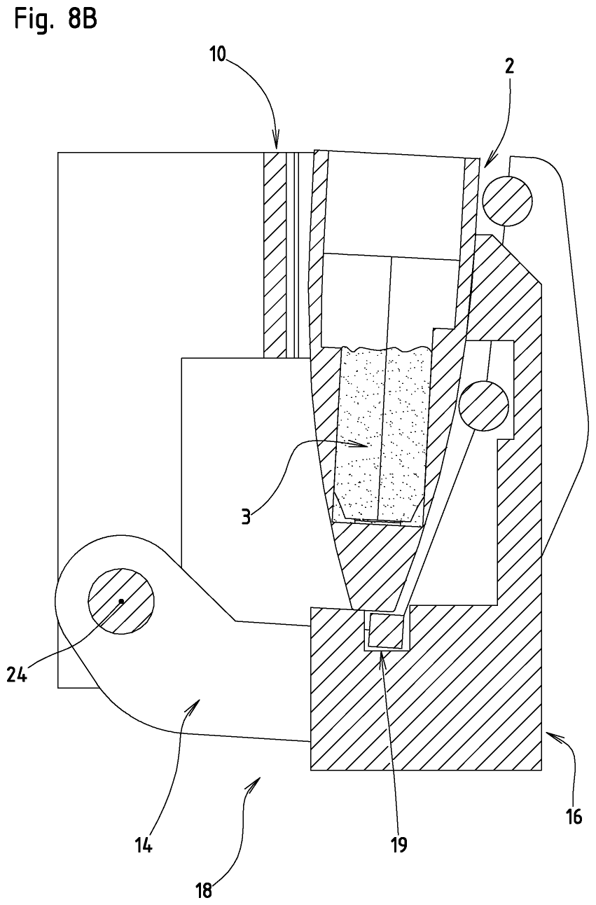

FIG. 8A shows a view in perspective of the first alternative embodiment of the weighing station 7 and transport device 50 in the weighing configuration 18. FIG. 8B shows a cross sectional view of the first alternative weighing station 7 and transport device 50 along line B-B of FIG. 8A. The transport support member 14 is pivoted about the pivot axis 24 to a lower position. Each device part 2 is now fully supported by one and only one weighing support member 16.

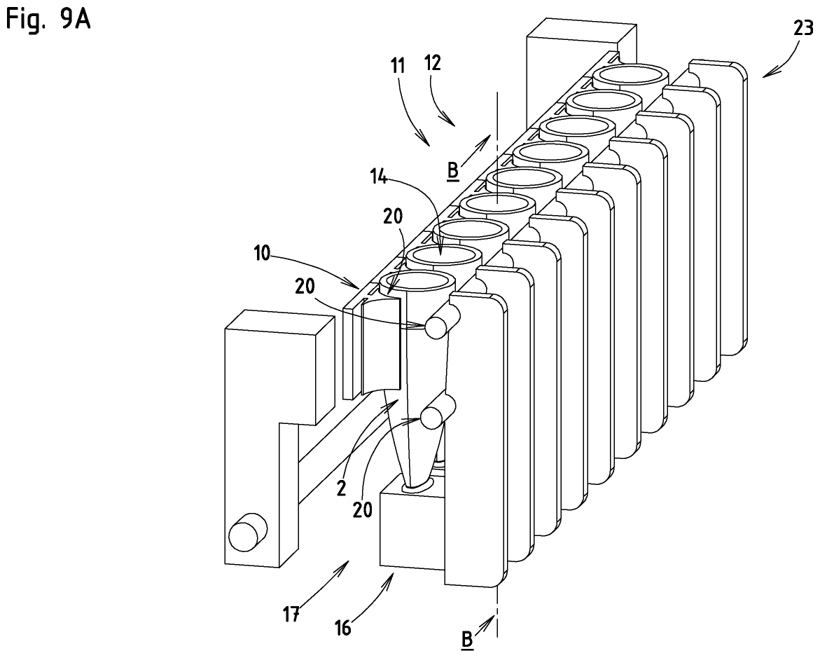

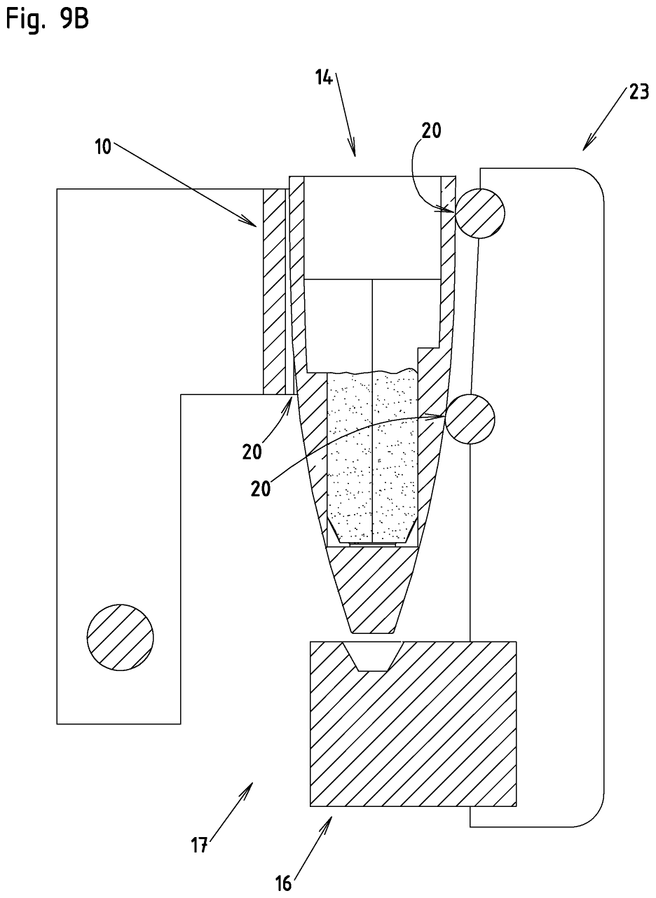

FIG. 9A a view in perspective of a second alternative embodiment of the weighing station 7 and transport device 50 in the transport configuration 17. FIG. 9B shows a cross sectional view of the second alternative weighing station 7 and transport device 50 along line B-B of FIG. 9A. The device parts 2 are located in the weighing positions 12 and are in the vertical direction 41 fully supported by the transport support members 14 formed by support surfaces 20 of the moving members 10 and the guide member 23.

FIG. 10A shows a view in perspective of the second alternative embodiment of the weighing station 7 and transport device 50 in the weighing configuration 18. FIG. 10B shows a cross sectional view of the second alternative weighing station 7 and transport device 50 along line B-B of FIG. 10A. The weighing support members 16 have been moved in the vertical direction 41 and each device part 2 is now fully supported by one and only one weighing support member 16.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

It will be apparent to those skilled in the art that various modifications can be made to the system without departing from the scope as defined in the claims.

1.-34. (canceled)

35. A system for filling device parts of simulated smoking devices, such as cartridges of electronic cigarettes, with a fluid, said system comprising:
a filling station to discharge a predetermined amount of fluid in each of the device parts,
a weighing station to individually weigh the device parts filled by the filling station, which weighing station provides a measurement signal for each of the device parts,
a control unit to determine if the predetermined amount of fluid has been discharged in each of the device parts on basis of the measurement signal, which control unit is in communication with the weighing station,
a transport device to move the device parts along a production trajectory, wherein:
the production trajectory extends through the filling station and the weighing station,
the transport device is configured to move a batch of at least one device part in at least one weighing position located in a weighing trajectory part of the production trajectory and subsequently out of the at least one weighing position, which weighing trajectory part extends through the weighing station,
the transport device comprises at least one transport support member to fully support the batch of at least one device part in a vertical direction during movement along the weighing trajectory part,
the weighing station comprises at least one weighing support member located at the at least one weighing position to support the batch of at least one device part during weighing by the weighing station, and
the at least one transport support member and the at least one weighing support member are movable relative to each other in the vertical direction;
from a transport configuration in which the batch of at least one device part is fully supported in the vertical direction by the at least one transport support member to move the batch of at least one device part into the at least one weighing position and subsequently out of the at least one weighing position,
into a weighing configuration in which the batch of at least one device part located in the weighing position is fully supported in the vertical direction by the at least one weighing support member to individually weigh each device part of the batch of at least one device part with the weighing station, and vice versa.

36. The system according to claim 35, wherein the transport device is configured to move the device parts first through the filling station and subsequently through the weighing station.

37. The system according to claim 35, wherein the at least one transport support member comprises a support rail which extends along the weighing trajectory part and the batch of at least one device part is in the transport configuration supported by the support rail.

38. The system according to claim 37, wherein the batch of at least one device part is in the transport configuration fully supported by the support rail.

39. The system according to claim 35, wherein:
the transport device comprises moving members for moving the batch of at least one device part along the weighing trajectory part and/or a guide member extending along the weighing trajectory part,
the at least one transport support member comprises support surfaces provided in the moving members and/or the guide member, and
the batch of at least one device part is in the transport configuration supported by the support surfaces.

40. The system according to claim 39, wherein the batch of at least one device part is in the transport configuration fully supported by the support surfaces.

41. The system according to claim 35, wherein in the weighing configuration, each weighing support member supports one and only one device part of the batch at least one of device part.

42. The system according to claim 35, wherein the batch of at least one device part located in the at least one weighing position is in the weighing configuration only supported by the at least one weighing support member.

43. The system according to claim 35, wherein the at least one transport support member and the at least one weighing support member are both moveable in the vertical direction to change from the transport configuration into the weighing configuration, and vice versa.

44. The system according to claim 35, wherein only the at least one transport support member is moveable in the vertical direction to change from the transport configuration into the weighing configuration, and vice versa.

45. The system according to claim 35, wherein the weighing support member is stationary.

46. The system according to claim 35, wherein only the at least one weighing support member is moveable in the vertical direction to change from the transport configuration into the weighing configuration, and vice versa.

47. The system according to claim 35, wherein:
the system comprises a further weighing station to individually weigh the device parts before filling by the filling station, which further weighing station provides a further measurement signal for each of the device parts,
the control unit is in communication with the further weighing station to determine if the predetermined amount of fluid has been discharged in each of the device parts on basis of the measurement signal and the further measurement signal,
the production trajectory extends through the further weighing station,
the transport device is configured to move the batch of at least one device part in at least one further weighing position located in a further weighing trajectory part of the production trajectory and subsequently out of the at least one further weighing position, which further weighing trajectory part extends through the further weighing station,
the transport device comprises at least one further transport support member to fully support the batch of at least one device part in the vertical direction during movement along the further weighing trajectory part,
the further weighing station comprises at least one further weighing support member located at the at least one further weighing position to support the batch of at least one device part during weighing by the further weighing station,
the at least one further transport support member and the at least one further weighing support member are movable relative to each other in the vertical direction;
from a further transport configuration in which the batch of at least one device part is fully supported in the vertical direction by the at least one further transport support member to move the batch of at least one device part into the at least one further weighing position and subsequently out of the at least one further weighing position,
into a further weighing configuration in which the batch of at least one device part located in the further weighing position is fully supported in the vertical direction by the at least one further weighing support member to individually weigh each device part of the batch of at least one device part with the further weighing station, and vice versa.

48. The system according to claim 35, wherein the transport device is configured to move the batch of at least one device part along the production trajectory in an intermittent manner.

49. The system according to claim 35, wherein the transport device is configured to move the at least one transport support member in the vertical direction and/or the weighing station is configured to move the at least one weighing support member in the vertical direction in order to move the at least one transport support member and the at least one weighing support member relative to each other from the transport configuration into the weighing configuration, and vice versa.

50. The system according to claim 35, wherein the transport device is configured to intermittently move subsequent batches of at least one device part along the production trajectory and in the at least one weighing position.

51. The system according to claim 35, wherein the transport device is configured to for a predetermined time period stop the movement along the production trajectory of the batch of at least one device part being located in the at least one weighing position.

52. The system according to claim 35, wherein the transport device is configured to move the at least one further transport support member in the vertical direction and/or the further weighing station is configured to move the at least one further weighing support member in the vertical direction in order to move the at least one further transport support member and the at least one further weighing support member relative to each other from the further transport configuration into the further weighing configuration, and vice versa.

53. The system according to claim 35, wherein the transport device is configured to intermittently move subsequent batches of at least one device part along the production trajectory and in the at least one further weighing position.

54. The system according to claim 35, wherein the transport device is configured to for a predetermined time period stop the movement along the production trajectory of the batch of at least one device part being located in the at least one further weighing position.
